(19) United States
(12) Patent Application Publication
(10) Pub. No.: US 2023/0260334 A1
(43) Pub. Date: Aug. 17, 2023

(54) SYSTEMS, DEVICES AND METHODS FOR OPERATING A VEHICLE WITH SENSORS MONITORING PARAMETERS

(71) Applicants: Sony Group Corporation, Tokyo (JP); Sony Europe B.V., Surrey (GB)

(72) Inventor: Renaud DI FRANCESCO, London (GB)

(21) Appl. No.: 18/016,241

(22) PCT Filed: Jun. 23, 2021
(86) PCT No.: PCT/GB2021/051591

§ 371 Date: Jan. 13, 2023

(30) Foreign Application Priority Data
Jul. 29, 2020 (GB) 2011799.0

(51) Int. Cl. G07C 5/00; G07C 5/08; G06V 20/56; B60W 60/00; G06Q 40/08

(52) U.S. Cl. CPC G07C 5/008; G07C 5/0866; G06V 20/56; B60W 60/00; G06Q 40/08; B60W 2756/10; B60W 2420/42

(57) ABSTRACT

A method of operating a vehicle is provided. The method includes monitoring, by control circuitry in combination with one or more sensors in the vehicle, one or more parameters indicating a motion of the vehicle over a time period, capturing, by one or more cameras in the vehicle, one or more images of a region surrounding the vehicle over the time period; detecting, by the control circuitry in the vehicle based on the monitored parameters, that a risk action has been performed by the vehicle at a time within the time period, transmitting, by transmitter circuitry in combination with the control circuitry in the vehicle, image data of the one or more images of the region surrounding the vehicle and measurements of the monitored parameters indicating the motion of the vehicle over the time period to a server along with an indication that the risk action has been performed.

### BACKGROUND

The present technique relates to systems, devices and methods for operating a vehicle, which includes one or more sensors for monitoring one or more parameters over a time period for identifying that a risk action has been performed by the vehicle in the time period and one or more cameras in the vehicle for capturing one or more images of a region surrounding the vehicle over the time period.

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present disclosure

Vehicle insurance is known to provide financial protection for vehicle drivers or driverless/autonomous vehicles against physical damage to the vehicles or injury to drivers or other road users or pedestrians, which may result from traffic accidents.

An insurer can compensate or indemnify a driver or owner of a driverless vehicle if damage occurs as a result of a traffic accident, according to an insurance policy. A driver or owner of a vehicle typically pays “insurance premiums” to the insurer. The insurance premiums are regular payments made by the driver to the insurer to keep the insurance policy active (in other words, to keep the driver insured). Insurance premiums are set by the insurer based on an assessed risk of whether the driver of the vehicle is likely to be involved in a traffic accident. For example, insurance premiums may be dependent on the: age of the driver, a type of the vehicle, age of the vehicle, previous accident history of the driver or the like. The insurer will typically set higher insurance premiums for drivers which are more likely to be involved in traffic accidents and vice versa.

Vehicle telemetry systems have been introduced in manual and autonomous vehicles to monitor and report a driving behaviour of vehicle drivers to assist in calculating risk factors for driver used to calculate insurance premiums. For example, vehicle telemetry systems may report evidence that a vehicle driver has engaged in risky driving behaviours such as harsh braking, acceleration/deceleration, changes in direction or the like to a server belonging to an insurer. The insurer may adjust an insurance premium of the driver based on the evidence of the risky driving behaviours. For example, if a vehicle telemetry system reports that a driver often accelerates and brakes harshly, the insurer may determine that the driver is likely to be involved in a traffic accident and increases an insurance premium for the driver accordingly.

### SUMMARY OF DISCLOSURE

Embodiments of the present technique can provide a method of operating a vehicle. The method includes monitoring, by control circuitry in combination with one or more sensors in the vehicle, one or more parameters indicating a motion of the vehicle over a time period, capturing, by one or more cameras in the vehicle, one or more images of a region surrounding the vehicle over the time period; detecting, by the control circuitry in the vehicle based on the monitored parameters, that a risk action has been performed by the vehicle at a time within the time period, transmitting, by transmitter circuitry in combination with the control circuitry in the vehicle, image data of the one or more images of the region surrounding the vehicle and measurements of the monitored parameters indicating the motion of the vehicle over the time period to a server along with an indication that the risk action has been performed.

Embodiments of the present technique can provide a server comprising a processor and a communications interface and executable code. When the executable code is executed, the processor is caused to perform the steps of receiving via the communications interface image data of one or more images of a region surrounding a vehicle and measurements of one or more monitored parameters indicating a motion of a vehicle over a time period with an indication that a risk action has been performed, determining, by control circuitry in the server based on at least the image data of the one or more images, that the risk action was performed in view of mitigating circumstances; calculating, by the control circuitry in the server, a risk factor for the driver indicating a likelihood that the driver will be involved in a road traffic accident at a future time later than the time period based on at least the measurements of the monitored parameters, wherein the calculating of the risk factor accounts for the risk action having been performed in view of the mitigating circumstances.

Current vehicle telemetry systems do not take into account whether risky driving behaviours may have been justified. In other words, there may have been mitigating circumstances for a driver performing risky driving behaviours in particular for cases when a collision would have otherwise been unavoidable (for example, a driver may have braked harshly because a squirrel suddenly ran across the road).

Determining whether mitigating circumstances are present when a driver engages in risky driving behaviours and accounting for the mitigating circumstances in risk factor calculation therefore represents a technical problem which are addressed by example embodiments described in the following paragraphs.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 illustrates an overview of a wireless communications system in accordance with exemplary embodiments;

FIG. 2 is a block diagram illustrating a vehicle apparatus in accordance with exemplary embodiments;

FIG. 3 illustrates an example of a risk action being performed by a vehicle in view of actions of a hedgehog in accordance with exemplary embodiments;

FIG. 4 is a flow diagram illustrating a processing procedure performed by a vehicle apparatus to determine whether or not a risk action was performed by a vehicle in accordance with exemplary embodiments;

FIG. 5 is a block diagram illustrating a risk calculating server in accordance with exemplary embodiments;

FIG. 6 is a schematic diagram illustrating an example of an Edge server and insurance server in accordance with exemplary embodiments;

FIG. 7 is a schematic diagram illustrating an example of communications between risk calculating servers and an insurance risk statistics supervisor;

FIG. 8 is a flow diagram illustrating a processing procedure performed by a risk calculating server to determine whether or not mitigating circumstances were present during a risk action performed by a vehicle in accordance with exemplary embodiments;

FIG. 9 is illustrates an example of periodically transmitted telemetry information in accordance with exemplary embodiments;

FIG. 10 is illustrates an example of a time before a risk action occurs in view of mitigating circumstances in accordance with exemplary embodiments;

FIG. 11 is illustrates an example of a time before a risk action occurs when mitigating circumstances are not present in accordance with exemplary embodiments;

FIG. 12 illustrates three different scenarios in which low, medium and high mitigation markers may be attached to telemetry information in accordance with exemplary embodiments.

FIG. 13 is a flow diagram illustrating a processing procedure performed by a vehicle apparatus to determine whether or not a risk action was performed autonomously by a vehicle in accordance with exemplary embodiments;

FIG. 14 is a flow diagram illustrating a processing procedure performed by a risk calculating server to determine whether or not a risk action was performed autonomously by a vehicle in accordance with exemplary embodiments;

FIG. 15 is a flow diagram illustrating a method performed by a vehicle in accordance with exemplary embodiments; and

FIG. 16 is a flow diagram illustrating a method performed by a server in accordance with exemplary embodiments.

### DESCRIPTION OF EXAMPLE EMBODIMENTS

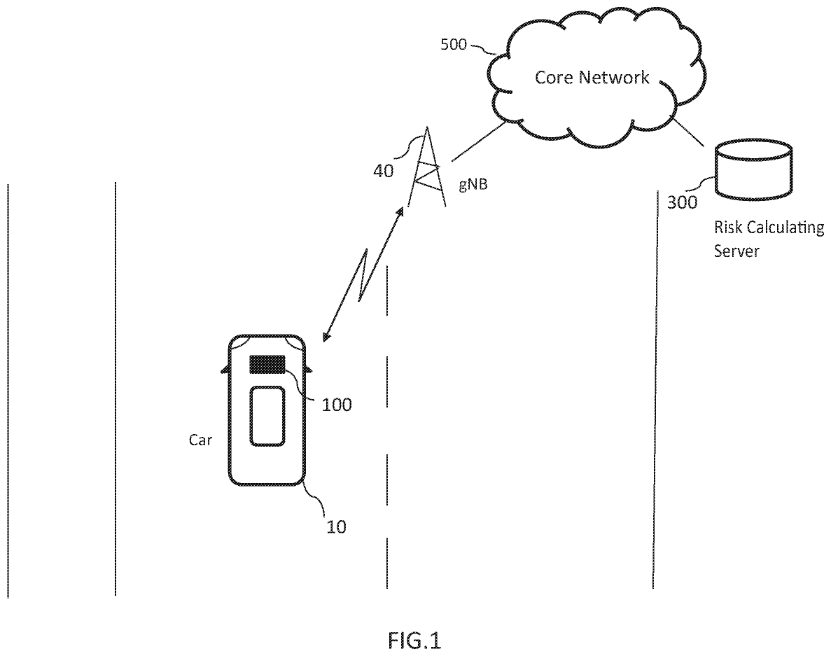

FIG. 1 provides an example of a wireless communications network for transmitting telemetry information from a vehicle apparatus in a vehicle to a risk calculating server for calculating a risk factor for a driver of the vehicle in accordance with example embodiments. FIG. 1 illustrates a car 10 comprising a vehicle apparatus 100 configured to communicate with a risk calculating server 300 via a gNB 40 and a core network 500. In accordance with exemplary embodiments, the vehicle apparatus 100 may periodically transmit telemetry information to the risk calculating server 300. The telemetry information may include one or more of images of a region surrounding the vehicle, a location of the vehicle, a direction of the vehicle, an acceleration of the vehicle, a current time, a speed of the vehicle or the like as will be explained in more detail below.

It will be appreciated that a car is an example of a vehicle and any vehicle with a vehicle apparatus 100 configured to communicate with the gNB 40 may be used. For example, the vehicle may be a motorcycle, aircraft, bus, train or the like. The vehicle may be driven by manually by a driver or the vehicle could be an autonomous or self-driving vehicle. The vehicle could be an autonomous or self driving vehicle that allows a driver or operator to take control of all or some driving functions at will or in some prescribed circumstances.

It will be appreciated that the gNB 40 is a radio access point to the core network 500 and any radio access point to the core network 500 which is configured to communicate with the car 10 may be used. For example, the radio access point to the core network 500 may be an eNB, Distributed Unit (DU), transmission and reception point (TRP), Central Unit (CU) or the like. In other examples the gNB could be a WiFi access point.

The risk calculating server 300 may receive the telemetry information periodically transmitted by the car 10 to determine a risk factor for a driver of the car 10. The risk calculating server 300 may be configured to identify, from the telemetry information, whether or not risk actions performed by the car were performed in view of mitigating circumstances and adjust the risk factor accordingly.

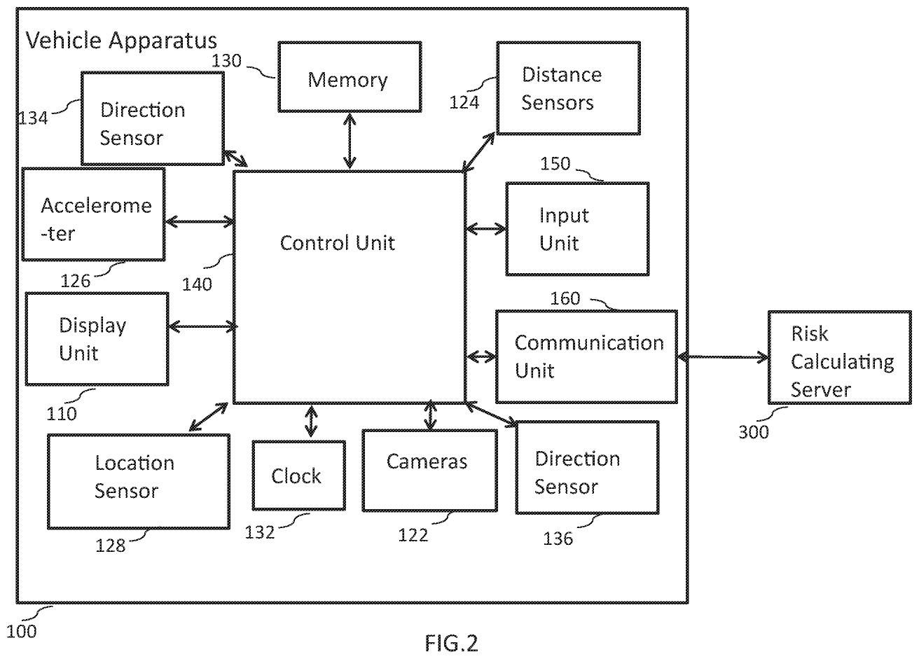

Example embodiments can provide a risk calculation improvement system, which can be used in one application to provide more accurate insurance premiums for drivers. As shown in FIG. 2, a vehicle apparatus 100 is implemented in the car 10. The vehicle apparatus 100 is configured to identify whether or not the car 10 has performed a risk action and to communicate telemetry information to the risk calculating server 300.

Identifying a Risk Action

The vehicle apparatus 100 is configured to monitor one or more parameters regarding a motion of the vehicle 10 and to determine if a risk action was performed by a driver of a vehicle. A risk action is any action performed by the vehicle which increases a likelihood of a traffic accident under normal circumstances. For example, a risk action may be one or more of sudden braking, sudden acceleration, a sudden change in direction of the vehicle, driving over a legal speed limit, deviation from a particular lane or the like. As will be appreciated, a vehicle may perform a risk action because of careless/recklessness of a driver of the vehicle. However, there may be circumstances in which a risk action may be necessary to avoid a collision. To obtain a more accurate risk factor, risk actions performed under such circumstances should not contribute significantly (if at all) to the calculation of the risk factor. Such circumstances will be referred to herein as “mitigating circumstances”.

Risk actions may be performed autonomously by autonomous/self-driving vehicles or manually by drivers of vehicles. For example, a risk action performed by an autonomous vehicle may be Automated Emergency Braking (AEB)) whereas a risk action performed manually by a driver of the vehicle may be the driver pressing hard on the brakes.

In other examples, the driver may turn the steering wheel sharply, thereby altering the direction of the vehicle, to avoid an object in a region surrounding the vehicle. In some embodiments, braking and steering behavior may cause automated systems, (such as traction or stability control) to alter power delivery to each or some of the vehicle's wheels. Initiation of such automated systems may indicate that a risk action has occurred. Embodiments of the present disclosure can serve to identify whether a risk action has occurred and include an indication that a risk action has occurred in telemetry information transmitted to a risk calculating server. The risk calculating server then identifies whether the risk action was performed in view of mitigating circumstances. The risk calculating server may then adjust a risk factor for the driver of the vehicle to account for the mitigating circumstances. Therefore an accuracy of insurance premiums calculated on a basis of the risk factor may be improved.

FIG. 2 shows a vehicle apparatus 100 according to example embodiments. According to FIG. 2, the vehicle apparatus 100 comprises a control unit 140 which is configured to receive information from and/or provide information to a communication unit 160, an input unit 150, a display unit 110, a memory 130, distance sensors 124, cameras 122, a clock 132, a direction sensor 134, an accelerometer 126 and location sensors 128. It will be appreciated that FIG. 2 is an exemplary embodiment and not all of the units shown are required to achieve the effects of the present disclosure as will be explained below. The vehicle apparatus 100 may be a single unit as shown in FIGS. 1 and 2. In some embodiments, each of the units within the vehicle apparatus 100 may be distributed throughout the car 10. In general, the vehicle apparatus 100 is used herein to refer to the one or more of the units in FIG. 2.

In some embodiments, the vehicle apparatus may comprise one or more cameras 122. The one or more cameras 122 may be configured to capture one or more images or moving images of a region surrounding the vehicle over time as external image information. In some embodiments, a plurality of cameras 122 may be mounted on the vehicle to cover a 360 or near-360 degree perspective of the surrounding region. In some embodiments, the one or more cameras may include one or more cameras internal to the vehicle and which capture one or more images of an interior of the vehicle over time as internal image information. The one or more cameras 122 may provide the external and internal image information to the control unit 140.

In some embodiments the one or more cameras 122 derive feature data from the one or more images. For example, the feature data may comprise data about objects in the region surrounding the vehicle. The feature data may be transmitted to the risk calculating server 300. The feature data may be understood by Artificial Intelligence (AI) in the risk calculating server 300. Examples of feature data in images may include edges, corners, blobs, ridges or the like as will be appreciated by one skilled in the art.

References to “image data” herein may mean one or both of images or feature data derived from the images.

In some embodiments, the vehicle apparatus 100 may comprise one or more distance sensors 124. The distance sensors 124 may be Light Detection and Ranging (LIDAR) sensors or any type of Time-of-Flight sensor for example. The one or more distance sensors are configured to detect a distance of objects in the surrounding region from the one or more distance sensors on the vehicle over time as distance information. Examples of objects in the surrounding region are pedestrians, street furniture, cyclists other vehicles or the like. The distance sensors 124 sensors provide the distance information to the control unit 140.

In some embodiments, the vehicle apparatus 100 may comprise 100 a location sensor 128. The location sensor may be a Global Positioning System (GPS) or Global Navigation Satellite System (GNSS) for example. However, it will be appreciated that any location sensor configured to determine a location of the car 10 over time may be used. The location sensors provide a location of the car as location information to the control unit 140.

In some embodiments, the vehicle apparatus 100 may comprise a clock 132. The clock, may be used to record a passage of time as time information and provide the time information to the control unit 140. The time information may be associated with other information provided to the control unit 140. For example, the time information 132 may be used to identify a time at which an image was taken by one or more of the cameras 122.

In some embodiments, the vehicle apparatus 100 comprises a speedometer 136. The speedometer 136 may monitor speed of the car 10 and provide the speed of the car 10 over time to the control unit 140 as speed information. If the control unit 140 determines that a sudden change in speed has occurred on a basis of the speed information provided by the speedometer 136, then this may be an indication that a risk action has been performed by the car 10.

In some embodiments, the vehicle apparatus 100 optionally comprises an accelerometer 126. The accelerometer 126 may monitor an acceleration of the car 10 and provide the acceleration of the car 10 over time to the control unit 140 as acceleration information. If the control unit 140 determines that a sudden change in acceleration has occurred on a basis of the acceleration information provided by the accelerometer 126, then this may be an indication that a risk action has been performed by the car 10. However, in some embodiments, the acceleration information is calculated by the control unit 140 from the speed information and time information as will be appreciated by one skilled in the art.

In some embodiments, the vehicle apparatus 100 comprises a direction sensor 134. The direction sensor may monitor a direction of the car 10 over time and provide the direction of the car 10 to the control unit 140 as direction information. If the control unit 140 determines that a sudden change in direction has occurred on a basis of the direction information provided by the direction sensor 134, then this may be an indication that a risk action has been performed by the car 10.

The distance sensors 124, cameras 122, clock 132, location sensor 128, direction sensor 134 and accelerometer 126 provide distance information, external image information, internal image information, time information, location information, direction information, speed information and/or acceleration information respectively to the control unit 140. This information may be used by the control unit 140 to determine whether a risk action and has occurred as will be explained below.

The control unit 140 is configured to receive information from and provide information to one or more of the units in FIG. 2. The control unit 140 may determine, on a basis of the information provided by one or more of the units, whether a risk action has occurred.

For example, the accelerometer 126 may provide the control unit 140 with an acceleration of the vehicle over a period of time. If the control unit 140 determines that a rate of decrease in speed is above a pre-defined threshold, then it may determine that a risk action has been performed. The pre-defined threshold may be adaptive to any one or more of weather conditions, road surface conditions, vehicle condition (such as tyre or brake conditions) which may be input via sensors. In some embodiments the pre-defined threshold may thus be calculated immediately before the risk action takes place. The direction sensor 134 may provide the control unit 140 with the direction of the vehicle over a period of time. If the control unit 140 determines that a rate of change in the direction of the vehicle is above a pre-defined threshold, then it may determine that a risk action has occurred. In response to determining that a risk action has occurred, the control unit 140 may attach a risk action marker to telemetry information around a time at which the risk action occurred to be transmitted to the risk calculating server 300.

The communication unit 160 may comprise at least transmitter circuitry and is configured in combination with the control unit 140 to transmit telemetry information to the risk calculating server 300. In some embodiments, the communication unit additionally comprises receiver circuitry which is configured to receive signals.

As shown in FIG. 2, the vehicle apparatus 100 may include a memory 130 or data storage means. Image information, acceleration information, location information, time information and/or distance information may be provided to the memory 130 for storage continuously or at regular intervals for storage.

The acceleration information, speed information, distance information, external image information, internal image information, time information, location information, direction information and/or acceleration information are examples of telemetry information which may be periodically transmitted to the risk calculating server 300 by the communication unit 160.

The telemetry information may be used by the risk calculating server 300 to calculate a risk factor for a driver of the vehicle. In some embodiments, the control unit 140 may attach a risk marker to telemetry information recorded at around a time at which a risk action was determined to have occurred to notify the risk calculating server 300 that a risk action was performed as will be explained below.

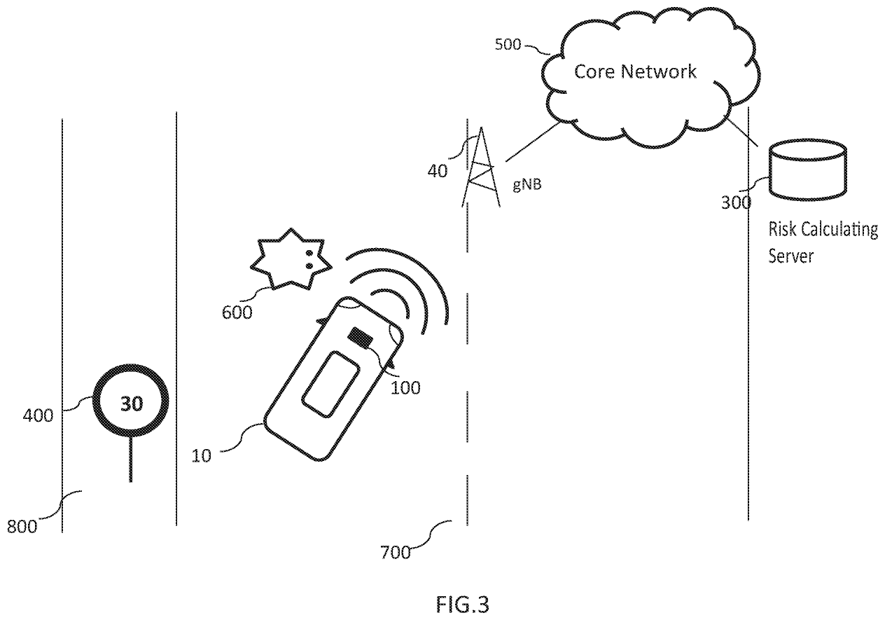

FIG. 3 is an example of a vehicle performing a risk action. As will be appreciated from FIG. 3, a car 10 configured with a vehicle apparatus 100 is driving along a road 700 within a speed limit 400 and is periodically communicating telemetry information to a risk calculating server 300 via a core network 500 and a gNB 40. A hedgehog 600 is on a pavement 800 adjacent to the road 700. The hedgehog 600 has strayed onto the road 700 and the car 10 changes direction/abruptly to avoid a collision with the hedgehog. In this example, the abrupt change in direction/swerving of the car 10 may be a risk action.

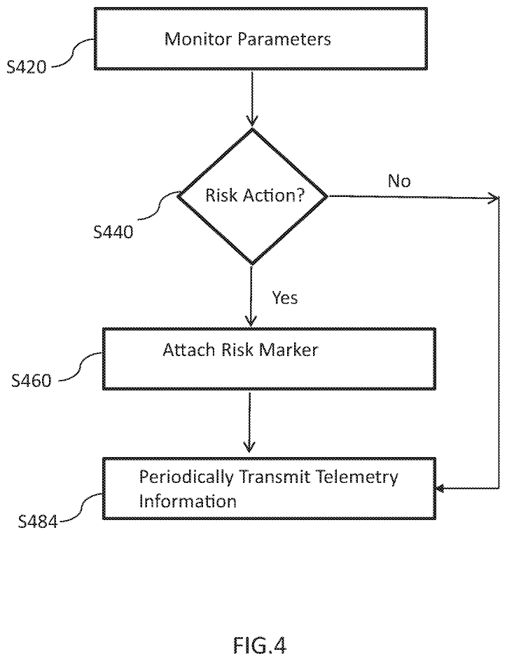

FIG. 4 is an example of a processing procedure performed by the vehicle apparatus 100 for determining whether a risk action has occurred and periodically transmitting telemetry information to a risk calculating server 300.

In step S420, the vehicle apparatus 100 monitors one or more parameters indicating a motion of the vehicle such as acceleration, speed, and direction of the car. In step S440, the control unit 140 of the vehicle apparatus 100 determines whether or not a risk action has occurred based on the one or more monitored parameters. If the control unit 140 determines that a risk action has not occurred, then processing proceeds to step S484 where the communication 160 of the vehicle apparatus 100 transmits telemetry information to a risk calculating server 300. As explained above, the telemetry information may include one or more of images of a region surrounding or inside the vehicle, a location of the vehicle, a direction of the vehicle, an acceleration of the vehicle, a current time, a speed of the vehicle or the like as will be explained in more detail below. In the example shown in FIG. 3, if a rate of change of direction of the vehicle with time is determined by the direction sensor 134 in combination with the control unit 140 to be above a pre-defined threshold, the control unit 140 may determine that a risk action has been performed. In other examples, the car 10 may have braked suddenly to avoid a collision with the hedgehog 600. In such examples, if a rate of change of speed of the vehicle determined by the accelerometer 126 in combination with the control unit is above a pre-defined threshold, the control unit 104 may determine that a risk action has been performed.

If the control unit 140 determines that a risk action has been performed then processing proceeds to step S460 and the control unit attaches a risk marker to telemetry information to be transmitted to the server 300. Specifically, the risk marker is attached to telemetry information captured at the time at which the risk action occurred. In other words, the control includes an indication with the telemetry information which is transmitted in step S484 that the telemetry information corresponds to information the time when a risk action occurred. Therefore, an insurer accessing the server will be able to easily locate telemetry information relating to risk actions and determine a risk factor for the driver accordingly.

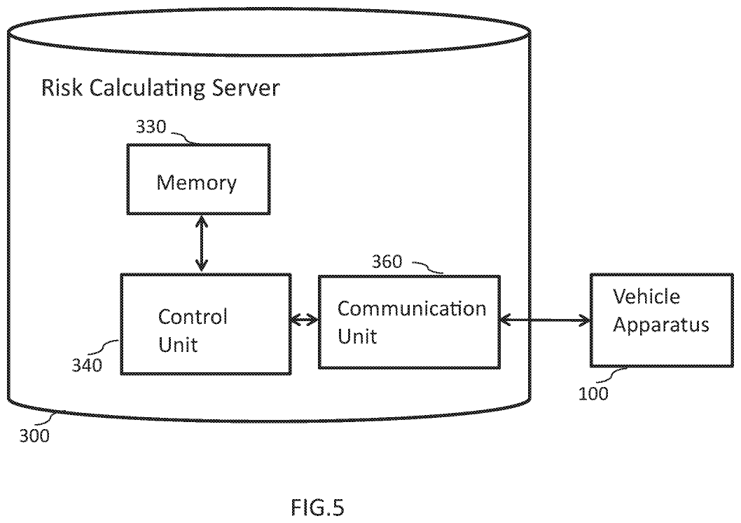

A risk calculating server according to exemplary embodiments is shown in FIG. 5. According to FIG. 5, the risk calculating server 300 comprises a control unit 140 which is configured to receive information from and/or provide information to a communication unit 360 and a memory 330.

The communication unit 360 may comprise at least receiver circuitry and is configured in combination with the control unit 340 to receive telemetry information from the vehicle apparatus 100. In some embodiments, the communication unit 360 additionally comprises transmitter circuitry which is configured to transmit signals.

The memory 330 is configured to store (either indefinitely or for a pre-determined period of time) to store telemetry information received from the vehicle apparatus 100.

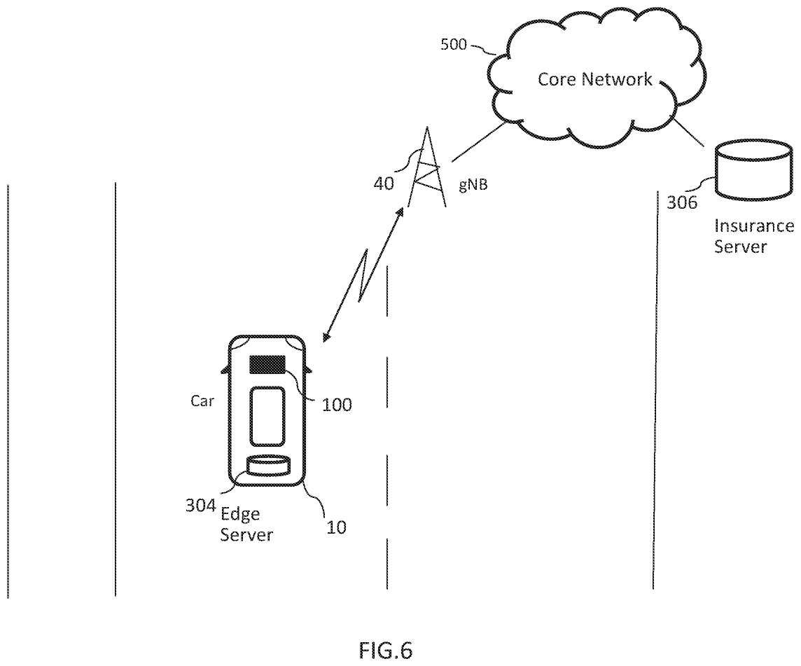

The risk calculating server 300 may be accessed by the vehicle apparatus 100 through the core network 500 as shown in FIG. 1. Alternatively, the risk calculating server 300 may form part of the core network 500. In example embodiments, the risk calculating server 300 may be an Edge Server 304 which may be onboard the vehicle 10 as shown in FIG. 6. The Edge server 304 may be configured to calculate and store risk factors calculated for a driver of the vehicle 10. The Edge server 304 may receive updates from a central insurance server 306 which may provide the Edge server 304 with an indication of how to calculate the risk factor for the insurance package used by the driver. For example, the way in which risk factors are calculated may be different depending on the type of vehicle or depending on technological advancements for autonomous vehicles. The updates from the insurance server may contain an insurance. Embodiments with an Edge server 304 reduce an exchange of information over the core network 500 and therefore reduce exposure to cybersecurity risks.

Embodiments with an Edge server 304 may allow for flexible insurance contract changes while maintaining data security and authenticity in the vehicle. For example, a driver of a vehicle may wish to be covered by a first insurance package for a first period of time and a second insurance package for a second period of time. For the first period of time, the insurance server 306 may transmit the first insurance package to the driver and the Edge server 304 calculates the risk factor and insurance premium for the driver. For the second period of time, the insurance server 306 may transmit the second insurance package to the driver and the Edge server 304 calculates the risk factor and insurance premium for the driver. In some embodiments, different insurance packages may be linked to different locations. For example, the vehicle apparatus 100 may transmit its location to the insurance server 306, and depending on the location, the insurance server 306 will transmit an insurance package to the Edge server 304. The particular insurance packages the insurance server 306 transmits to the Edge server depending on location and/or time may be pre-agreed by an insurance company and the driver of the vehicle.

An insurance package may be any pre-agreed insurance policy agreed between the driver of the vehicle and an insurance company as will be appreciated by one skilled in the art.

The Edge server 304 may be hardware onboard the vehicle or software running on a personal portable equipment such as a mobile phone. The Edge server 304 may contain an anti-tampering mechanism preventing fraudulent modification.

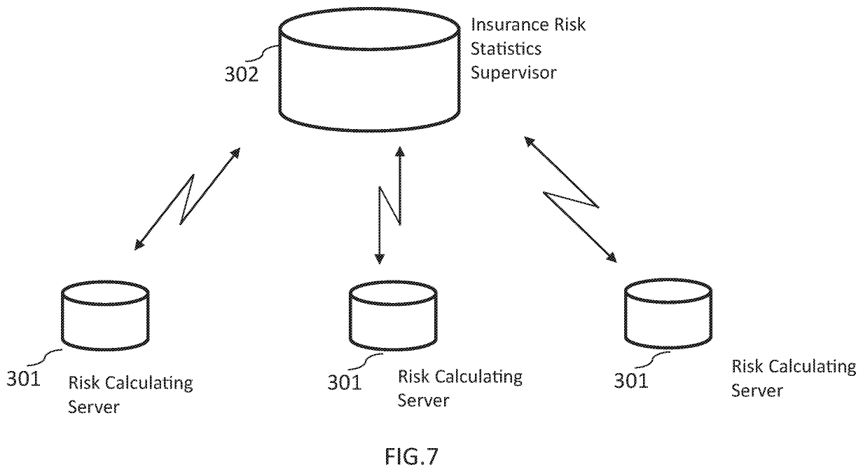

Example embodiments contain an “insurance risk statistics supervisor” for insurance company. An example of an insurance risk statistics supervisor 320 communicating with a plurality of risk calculating servers 301 is shown in FIG. 7. It will be appreciated that the risk calculating servers 301 may have broadly the same functionality as the risk calculating server in FIG. 1.

The supervisor 302 for the insurance company may receive data from each of the risk calculating servers 301. The data transmitted form the risk calculating servers 310 to the supervisor 302 may comprise: measurements of acceleration, speed, direction or the like of vehicles measured over a time period. Each risk calculating server may serve one or more vehicles. The supervisor 302 may aggregate the data received from each of the risk calculating servers 301 in order to refine the calculation of the risk factors carried out by the risk calculating servers.

For example, the supervisor 302 may aggregate data for all vehicles travelling through specific roads, in a geographic area, and the corresponding driving behaviors (such as acceleration, speed, direction or the like) and risk actions performed, matched with traffic and weather conditions and similar external factors (peak hours, construction in progress, water leak on the road, or the like).

The supervisor may aggregate the data by category of vehicles and insurance contract.

The aggregated data may be analysed to refine the calculation of the risk factors by ensuring that vehicles taking similar risks in similar situations are penalised or rewarded consistently. Updated methods of how to calculate risk factors may be communicated from the supervisor 302 to the risk calculating servers 301.

In some embodiments, the calculation of the risk factor can be further refined if data exchange between insurance companies occurs, leading to more accurate risk estimates in certain geographies and categories of vehicles or drivers and therefore a more accurate estimation of what risk actions may be justified given the circumstances.

Such embodiments can provide dynamic ways to update insurance contract premiums by harnessing new models such as pay per drive, pay per location, pay per day time or the like.

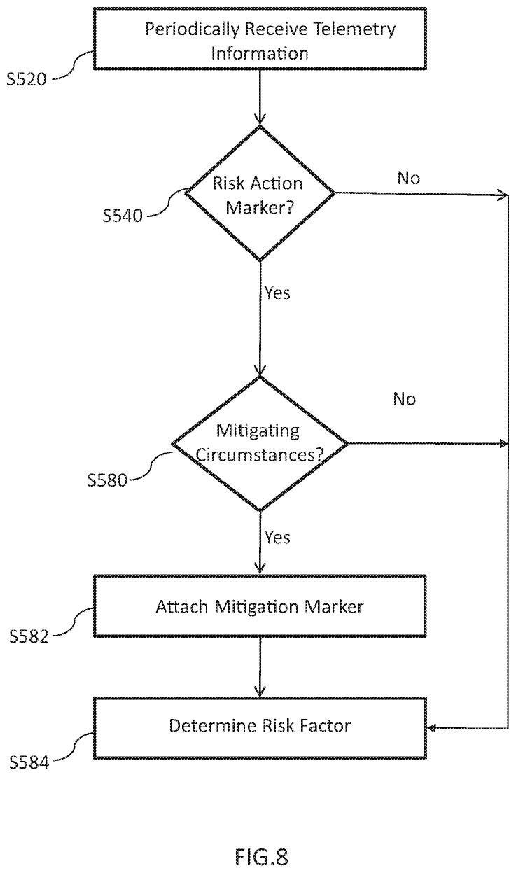

FIG. 8 is a flow diagram illustrating a processing procedure performed by the risk calculating server 300. As shown in FIG. 5, a risk calculating server 300 periodically receives the telemetry information from the communication unit 160 of the vehicle apparatus 100 in step S520. In step S520, the risk calculating server monitors the telemetry information to determine if the telemetry information has an attached risk action marker. In an example, a risk action marker may be an indication which is associated with images of a region surrounding the vehicle at a time at which the risk action occurred as well as information used to determine that the risk action occurred. For example, the telemetry information may include an acceleration, or a rate of change of direction of the vehicle at the time the risk action was performed or the like. If the risk calculating server 300 determines that no risk marker is present in the received telemetry information, then processing proceeds to step S584 and a risk factor for the driver of the vehicle is determined. However, if the risk calculating server 300 detects that a risk action marker is present, then the risk calculating server may analyze telemetry information corresponding to a time around when the risk action occurred to determine whether or not the risk action was performed in view of mitigating circumstances as explained below.

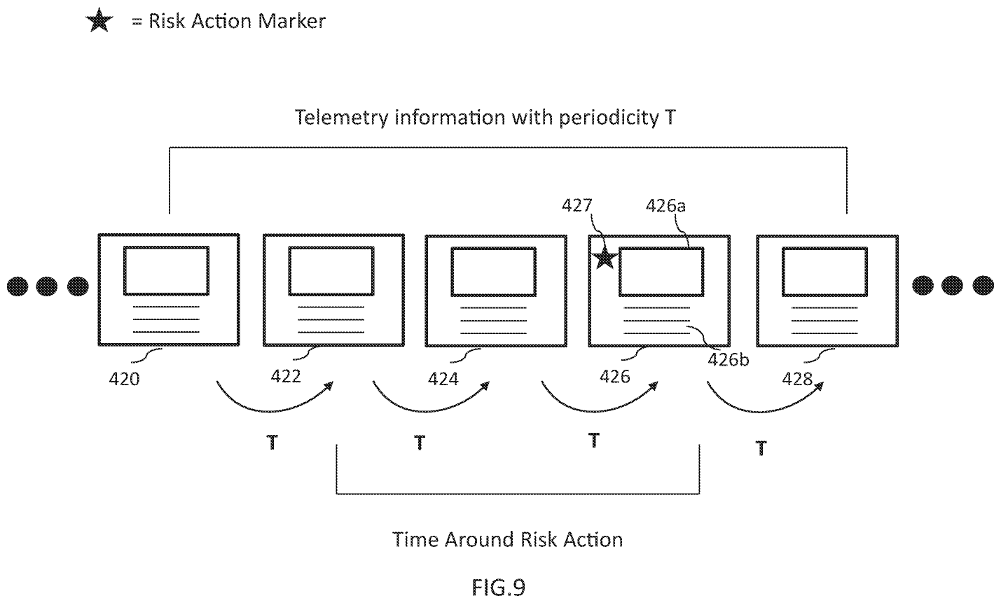

An example of the risk calculating server 300 monitoring telemetry information for risk markers is shown in FIG. 9. As illustrated in FIG. 9, five sets of telemetry information 420, 422, 424, 436, 428 each corresponding to a different time are periodically received by the risk calculating server 300 with periodicity “T”. The risk calculating server 300 monitors the five sets of telemetry information for risk markers. As will be appreciated from FIG. 9, a fourth set of telemetry information 426 has an associated risk marker 427. An image 426a of a region surrounding the vehicle/and or of a driver of a vehicle is included in the telemetry information along with additional information 426b regarding the vehicle. The additional information regarding the vehicle may comprise an acceleration, speed, direction, location of the vehicle, a distance of objects in a region surrounding the vehicle from the vehicle or the like at the time at which the fourth set of telemetry information 426 was captured. Once the risk calculating server has identified the risk marker 427, it may use telemetry information captured around the time at which the risk action occurred to determine whether or not the risk action was performed in view of mitigating circumstances. For example, the telemetry information captured around the risk action may include the second set of telemetry information 422 and the third set of telemetry information as shown in FIG. 9 to check for mitigating circumstances. Accordingly, the risk calculating server 300 may store received telemetry information.

In some embodiments, the control unit 140 may include an indication of how severe the risk action was in the risk marker. In some embodiments, there may exist a plurality of types of risk marker. For example the control unit 140 may attach a low risk, medium risk and high risk marker depending on whether a low risk, medium risk or high risk threshold is exceeded respectively. In examples, a high risk marker may be attached if particularly reckless driving is detected. For example, if the control unit 140 may detect that a low risk action has occurred if a vehicle is driving 5 mph over the speed limit, that a medium risk action has occurred if the vehicle is driving 10 mph over the speed limit and a high risk action has occurred if the vehicle is 15 mph or more over the speed limit.

Identifying Mitigating Circumstances

In some embodiments, a risk calculating server 300 may use image information of the region surrounding the vehicle provided by one or more cameras 122 to determine whether the risk action was performed in view of mitigating circumstances. The risk calculating server 300 may specifically use image information captured substantially around a time at which the risk action occurred to determine an identity objects in the region surrounding the vehicle. In some examples, the risk calculating server may use object recognition software to identify a likely cause of the risk action. For example, the image information may indicate a collapsed tree, traffic accident, stray animal or the like as the likely cause of the risk action. In some examples, the risk calculating server may determine that mitigating circumstances were present if an object obstructing a path of the vehicle is present at a time before the risk action occurs. In exemplary embodiments, the risk calculating server may use distance information provided by the distance sensors 124 in addition to the image information to determine whether the risk action was performed in view of mitigating circumstances. The risk calculating server 300 may use the distance information provided by one or more distance sensors to determine a distance between the vehicle and the identified objects in the surrounding region of the vehicle at a time substantially around when the risk action occurred. The risk calculating server may determine that mitigating circumstances were present for example if distances between the vehicle and the likely cause of the risk action was above/below a pre-defined threshold at a time before the risk action occurred. Object recognition may be performed by a processor identifying edges in image data which represent objects and differentiate them from a background of the image. These objects may then be then be correlated with known images to determine what the object might be, or at least identify aspects of the object such as size. In example embodiments, images may be segmented into multiple objects. Objects may be tracked from frame to frame in moving images, which in some embodiments may be useful for accuracy if objects overlap one another in the image. Distance sensors 124 may be used to detect a distance of objects in the region surrounding the vehicle from the vehicle.

In exemplary embodiments, as will be explained below, the risk calculating server may use other information, in addition to the image and distances information, to determine whether mitigating circumstances were present. For example, the risk calculating server may use whether or not a likely cause of the risk action was in a field of view of the driver at a time before the risk action, a speed, acceleration, direction of the vehicle and prevailing weather conditions at a time before the risk action occurred. In some embodiments, the risk calculating server may determine a probability representing a likelihood of how avoidable the risk action and determine that mitigating circumstances were present if the probability is below a pre-defined threshold.

After the risk calculating server has identified that a risk action has occurred in the received telemetry information by detecting a risk marker, the risk calculating server may determine whether or not the risk action was performed in view of mitigating circumstances in step S580. A risk action is performed in mitigating circumstances if it was necessary that the risk action was performed to avoid a collision for reasons outside the driver's control. For example, if the hedgehog suddenly dashed out onto the road 800 in front of the car 10 which was otherwise driving safely, the driver may have been required to perform the risk action to avoid a collision with the hedgehog. The risk calculating server 300 may analyze one or more images of a region surrounding the vehicle at a time before the risk action provided by the telemetry information in order to determine whether the risk action was avoidable and therefore whether or not mitigating circumstances were present.

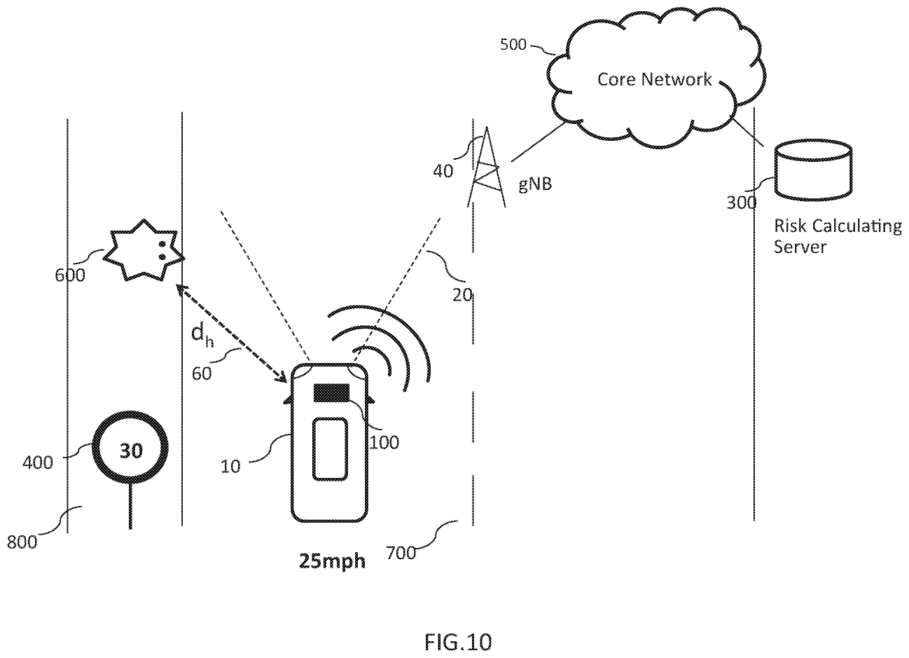

For example, in FIG. 10, at a time before the risk action, the car 10 is driving safely. The car 10 is transmitting telemetry information which may, at the instant shown in FIG. 10, correspond to the second or third set of telemetry information 422, 424 in FIG. 9. The risk calculating server 300 may determine that the car 10 is driving under the speed limit 400 (in this example, the speed limit 400 is 30 mph and the car is driving at 25 mph). The risk calculating server 300 may determine that the hedgehog is a likely cause of the risk action. The risk calculating server 300 may determine that the hedgehog is outside a field of view 20 of the driver. The risk calculating server 300 may determine that the hedgehog is a distance “dₕ” 60 away from a distance sensor on the car 10 and further determine that the distance 60 is above a pre-defined threshold. Using one or more of these determinations, the risk calculating server 300 may determine that the driver of the vehicle 10 was driving safely and that the risk action shown in FIG. 8 was unavoidable. The control unit 140 may therefore determine that a probability representing a likelihood of how avoidable the risk action was is below a pre-defined threshold and therefore that mitigating circumstances were present.

In some embodiments, the risk calculating server 300 may determine a likelihood that the hedgehog will intersect a path of the vehicle. For example, the risk calculating server 300 may track the distance of the hedgehog from the vehicle over a period of time before the risk action was performed. The risk calculating server 300 may estimate a speed of the hedgehog. The risk calculating server 300 may use the speed, direction and/or acceleration in combination with the speed and/or distance of the hedgehog from the car to determine a likelihood intersection. For example, the risk calculating server 300 may use any dynamics equations known in the art to predict whether the hedgehog and car are on course to collide. If it is determined that the hedgehog and the car are likely to collide, the risk calculating server 300 use this information to determine whether the collision was avoidable. For example, if it is determined that the car 10 and hedgehog are on course to collide, the risk calculating server 300 may determine whether or not the hedgehog is in the field of view of the driver. If the hedgehog is not in the field of the driver, and it is predicted that a collision is likely to occur, it may be deemed that the risk action was unavoidable. Conversely, if it is determined that a collision is likely to occur and the hedgehog is within a field of view of the driver then it may be determined that the risk action was avoidable because the driver should noticed the hedgehog and slowed down in response.

It will be appreciated that the above examples are just some examples of how mitigating circumstances may be determined.

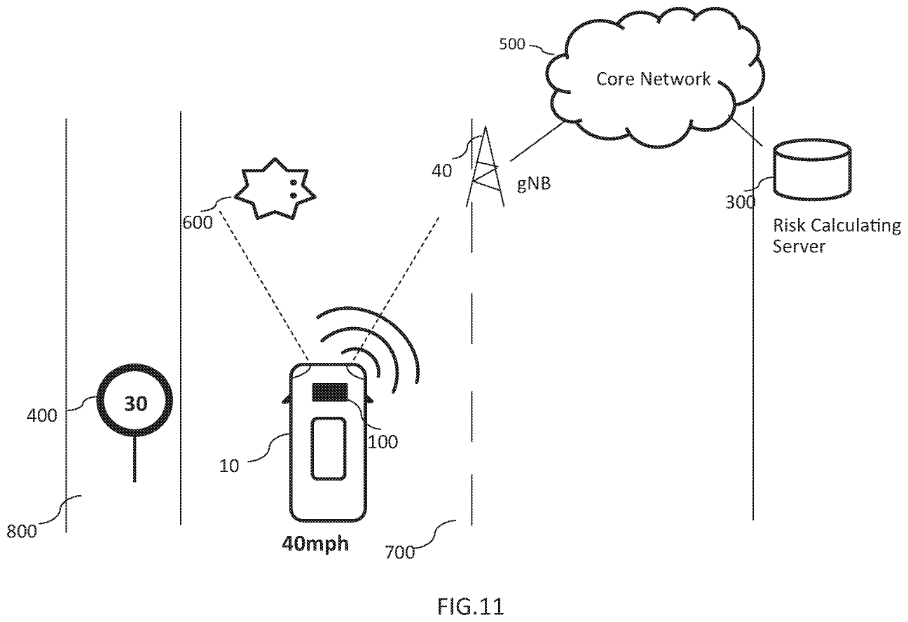

In some embodiments, the risk calculating server 300 may determine that mitigating circumstances were not present even though a risk action was performed. Such a situation is shown in FIG. 11. The car 10 is transmitting telemetry information which may, in this example, correspond to the second or third set of telemetry information 422, 424 in FIG. 9. The risk calculating server 300 may determine that the car 10 is driving over the speed limit 400 (in this example, the speed limit 400 is 30 mph and the car is driving at 40 mph). The risk calculating server 300 may determine that the hedgehog is inside a field of view 20 of the driver. The risk calculating server 300 may determine that the hedgehog is a distance “dₕ” 60 away from a distance sensor on the car 10 and further determine that the distance 60 is below a pre-defined threshold. Using one or more of these determinations, the control unit 140 may determine that the driver of the vehicle 10 did not take adequate consideration of his surroundings before the risk action and therefore that the risk action could have been avoided. The risk calculating server 300 may therefore determine that a probability representing a likelihood of how avoidable the risk action was is above a pre-defined threshold and therefore that mitigating circumstances were not present. In such cases, processing proceeds to step S484.

If the risk calculating server 300 determines that the risk action was performed in view of mitigating circumstances then processing proceeds to step S580 in FIG. 8 and the risk calculating server 300 attaches a mitigation marker to telemetry information to be transmitted to the server 300. In other words, the control includes an indication with the telemetry information which is transmitted in step S484 that the telemetry information corresponds to information captured at a time when a risk action occurred in view of mitigating circumstances.

Therefore, the risk calculating server 300 can easily locate telemetry information relating to risk actions in view of mitigating circumstances and determine a risk factor for the driver accordingly in step S584. In some embodiments, the risk calculating server 300 may delete telemetry information corresponding to a time at which a risk action in view of mitigating circumstances was deemed to occur. In such embodiments, the risk factor is calculated without consideration of risk actions performed in view of mitigating circumstances. In some embodiments the server circuitry is controlled by telemetry data retention rules. In some embodiments telemetry data is retained for a first predefined period. In some embodiments telemetry data is retained for a first predefined period before being averaged together with other telemetry. In some embodiments telemetry data relating to risk actions without mitigation is retained for a first predefined period whilst telemetry data relating to risk actions without mitigation is retained for a second, shorter predefined period. In some examples a driver of a vehicle may give consent to the retention of the telemetry data for a period in order to satisfy data protection requirements.

In some embodiments, the risk calculating server 300 may include an indication of how mitigating the circumstances were in the mitigation marker. In some embodiments, there may exist a plurality of types of mitigation marker. For example the risk calculating server 300 may attach a low mitigation, medium mitigation and high mitigation marker depending on whether a low mitigation, medium mitigation or high mitigation threshold is exceeded respectively. In examples, a high mitigation marker may be attached if the risk calculating server 300 determines that there was a particularly low probability of the driver being able to avoid performing the risk action.

In some embodiments, the risk calculating server may determine prevailing weather conditions around a time at which the risk action occurred. For example, the server may receive weather condition information from a weather service such as the Met Office. In other examples, the risk calculating server may use object recognition software on the images received from the vehicle apparatus substantially around the time at which the risk action was performed to determine the weather conditions. The determined weather conditions may be used to alter the probability representing a likelihood of how avoidable the risk action was. For example, the probability may be decreased if it is raining or if there is decreased visibility due to fog or the like. Alternatively, distance thresholds may be adaptive to weather conditions as explained above.

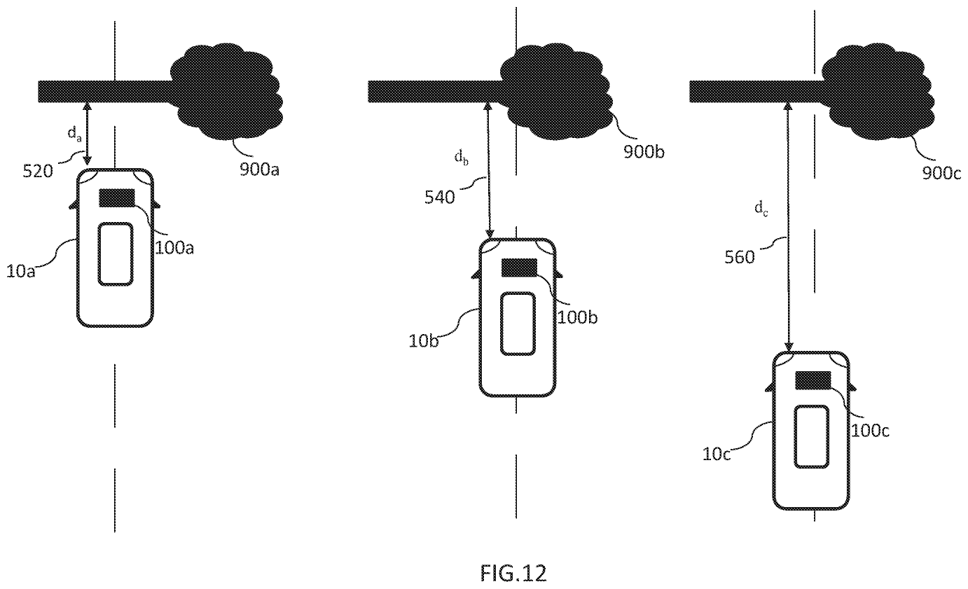

FIG. 12 illustrates an example scenario in which different mitigation markers may be attached. In FIG. 12, a driver of a first, second and third car 10a, 10b, 10c with a first, second and third respective vehicle apparatus 100a, 100b, 100c driving at 30 mph each perform emergency braking to avoid a collision with a first, second and third collapsed tree 900a, 900b, 900c respectively. Each Tree 900a-c collapses at the instant shown in FIG. 12. Each car 100a-c stops in two seconds resulting in a deceleration of 15 mph/s. A risk action threshold may be set at a deceleration of 10 mph/s. Therefore, in each case, control units in each of the vehicle apparatuses 100a-c determine that a risk action has been performed by each vehicle 10a-c. However, the first, second and third vehicles 100a-c are different distances (dₐ 520, d_{b} 540 and d_{c} 560 respectively) away from the respective collapsed trees 900a-c at the time at which the risk action was performed. The risk calculating server may compare the distances dₐ 520, d_{b} 540 and d_{c} 560 with a low, medium and high mitigation threshold respectively to determine which mitigation marker to attach in each case. In this example, the closer the vehicle was at the time the tree collapse, the higher the mitigation marker because it is less likely that the vehicle could have avoided performing the risk action. Accordingly, the risk action performed by the vehicles 100a, 100b, 100c may be assigned high, medium and low mitigation markers respectively. If the distance between the vehicle and the collapsed tree is larger than any of the distances shown in FIG. 12, the risk calculating server may determine that mitigating circumstances were not present because the driver had enough time to slow the vehicle gradually without resorting to sudden braking.

In some embodiments, risk markers and/or mitigation markers may be represented by a one bit flag. In some embodiments, such as when there are three types of marker (for example, low, medium and high as explained above), the risk markers may be represented by multiple bit flags.

Attachment of markers may be represented by assigning a field to a record in a database. The attached makers may be assigned in a hierarchy of structured data representing the telemetry data such as Hypertext Markup Language.

In some embodiments, a risk action may be performed autonomously (in semi or fully autonomous vehicles). In such embodiments, the control unit 140 may include an indication in the telemetry information transmitted to the server that the risk action was performed autonomously.

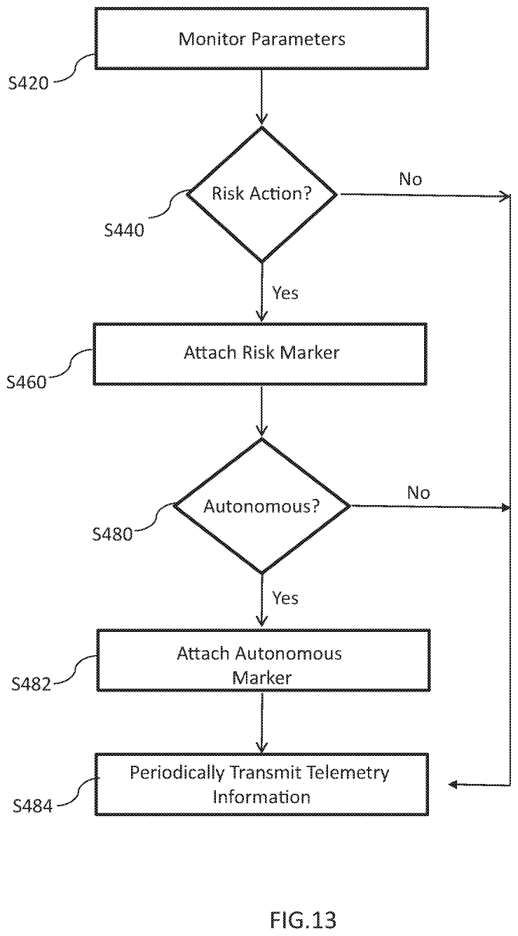

For example, FIG. 13 is based on FIG. 4 but includes additional steps taken by the control unit 140 to determine if a risk action was a result of an automated process. In step S480, after the control unit 140 has determined that a risk action has occurred and attached a risk marker to the telemetry information, the control unit 140 determines whether the risk action was performed autonomously by the vehicle. For example the control unit 140 may detect whether or not Automated Emergency Braking (AEB) or self-driving or other automated driving functions as will be appreciated by one skilled in the art were in operation at a time at which the risk action occurred. If the control unit 140 determines that the risk action was performed as a result of an automated process, then, in step S492, the control unit 140 may attach an autonomous marker to the telemetry information to be transmitted to the risk calculating server 300 in step 484. The autonomous marker includes an indication that the risk action was performed by an automated process.

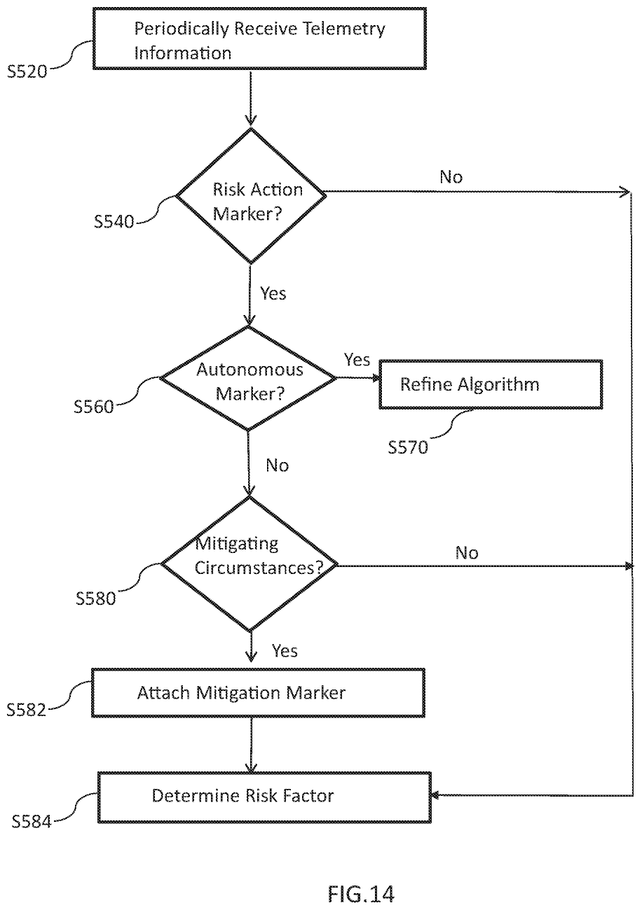

FIG. 14 illustrates an example of how the risk calculating server 300 may process an autonomous marker. As will be appreciated, FIG. 14 is based on FIG. 8 but includes additional steps for the risk calculating server to process an autonomous marker. In step S560 the risk calculating server 300 determines whether or not there is an autonomous marker attached to telemetry information received by from the communication unit 160 of the vehicle apparatus 100. If the risk calculating server 300 determines that there is an autonomous marker present, then processing proceeds to step S570. In step S570, the risk calculating server 300 may use the telemetry information from the time at which the risk action occurred to determine whether or not the automated process which performed the risk action was functioning correctly. For example, the risk calculating server may determine that the swerving shown in FIG. 3 was a correct use of the automated steering. However, the risk calculating server may determine that the steering was too sharp or occurred too early or too late. In such cases, the server may transmit feedback to the communication unit 160 of the vehicle apparatus so that algorithms used to determine when automated processes are engaged may be refined.

In some embodiments, the risk calculating server may use telemetry information with an autonomous marker to calculate a risk factor for the vehicle rather than for a driver for the vehicle. The risk calculating server may be accessed by an insurer who uses the risk factor for the vehicle to calculate insurance premiums for particular model of vehicle, a manufacturer of the vehicle or particular software version of the vehicle, or the like.

In some embodiments, the vehicle apparatus 100 may include information regarding the driver in the telemetry information transmitted to the risk-calculating server. For example, the one or more cameras 122 may comprise one more cameras internal to the vehicle and which image a driver of the vehicle over time. The control unit 140 of the vehicle apparatus 100 may include the one or more images internal to the vehicle to the risk calculating sever 300 in the telemetry in formation. In some embodiments, the control unit 140 may identify whether or not the driver of the vehicle took precautions to decrease a likelihood of a risk action being performed in advance of the risk action. For example, the control unit 140 may perform image analysis on the one or more images internal to the vehicle to determine if the driver checked mirrors of the vehicle, or was looking at the road 700 at a time before the risk action was performed. The control unit 140 may determine that mitigating circumstances were not present if the driver was not looking at the road for a pre-determined period of time before the risk action occurred.

In some embodiments, harsh braking for a small animal such as a hedgehog in the road may be a risk action without mitigating circumstances. In some embodiments, harsh braking for a small animal such as a hedgehog in the road may be a risk action with mitigation mitigating circumstances if a driver has checked rear view mirrors. In some embodiments, harsh breaking for a larger animal which may cause damage to a vehicle may be a risk action with mitigating circumstances. The vehicle apparatus 100 may determine the size of the animal. For example, the cameras 122 and/or distance sensors may be used to determine the size of the animal

Calculating the Risk Factor

The risk calculating server 300 may an identification of individuals, the vehicles they own and their insurance policies in the memory 330. However, in some cases an individual registered as owning the vehicle may not necessarily be the one driving it. For example, if a vehicle is temporarily lent by an owner in an authorized way to another user with separate insurance liabilities (such as a concierge parking service or lent to a family member), then embodiments can provide a means of contacting the server to provide an indication that a user other than the vehicle owner will be driving the vehicle for a period of time.

For example, the risk calculating server 300 may provide a service via an application which is accessible through an input unit 150 of the vehicle apparatus. A user of the vehicle may upload an indication to the server that the user will be driving the vehicle for a given period of time using the application. The user may indicate that alternative insurance is in place for this period of time and may insert temporary insurance policy number through the application for verification. In other embodiments, the service provided by the server may be accessible using a smartphone, computer, tablet or the like of the driver.

Embodiments can verify an identity of a driver of the vehicle. For example, the one or more cameras 122 of the vehicle apparatus may include, in addition to one or more external cameras for capturing images of a region surrounding the vehicle, one or more internal cameras for capturing images of the driver. The control unit 140 may transmit the one or more images of the driver to the risk calculating server 300 for verification of the identity of the driver. The risk calculating server 300 may compare the images of the driver to images in a storage unit of the server to determine an identity of the driver. The server 300 may then determine an insurance policy for the driver and proceed to calculate a risk factor for the driver.

This service provided by the risk calculating server 300 may be a subscription service in which a driver can obtain access to rental vehicles at different locations such as a car club or car sharing scheme. A subscription price for the service, or a variable per use price, may be influenced by a previously calculated risk factor for the driver. For example, a vehicle which is part of the scheme may transmit image data of a region surrounding a vehicle as well as measurements of one or more monitored parameters indicating a motion of the vehicle to the risk calculating server 300 during a time in which a particular driver is driving the vehicle. The risk calculating server 300 may calculate a risk factor for the driver which is stored in the risk calculating server along with an identity of the driver (which may be provided by the driver via an application for example). If the driver of the vehicle uses another vehicle in the scheme at a later time, the subscription price may be determined by the previously calculated risk factor. In example embodiments, a previously calculated risk factor from a vehicle driven by the driver outside the scheme (such as the driver's personal vehicle) may be imported to the risk calculating server 300 and used to determine a subscription price for the driver.

As will be appreciated from Equation 1 below, a risk factor for a driver of the vehicle may be calculated as a function of driver information (such as driver age, sex, driving experience or the like), vehicle information (such as vehicle age, model or the like), risk actions (evidence of harsh braking, acceleration, swerving or the like received from a vehicle apparatus 100) and mitigating circumstances (deductions from the risk action because the risk actions were necessary to avoid a collision). The risk factor is an indication of how likely a driver of the vehicle will be involved in a traffic accident at a future time.

Risk Factor=f[driver information,vehicle information,risk actions,mitigating circumstances] Equation 1.

An insurer of the driver of the vehicle may access the risk factor via the risk calculating server 300 and use the risk factor in combination with an agreed insurance policy with the driver to calculate insurance premiums for the driver.

In accordance with exemplary embodiments, the risk factor has a positive correlation with a number of risk actions which have been reported by the vehicle apparatus. The risk factor may also have a positive correlation with a severity of the risk actions. As explained above, the control unit 140 of the vehicle apparatus may include an indication of how severe a risk action was in the risk marker (for example, the control unit 140 may attach a low, medium or high risk action marker).

In some embodiments, the risk calculating server 300 may disregard and/or delete telemetry information which has a mitigation marker. In other words, the risk factor calculation may be based only on risk actions which did not have mitigating circumstances. In such embodiments, an accuracy of the risk factor is improved because drivers should not be penalised for performing risk actions in view of mitigating circumstances.

In some embodiments, the risk calculating server reduces an impact of a risk action on the risk factor if the risk action was performed in mitigating circumstances. As explained above, the impact of the risk action on the risk factor may be reduced further if the less likely it was that the risk action could be avoided as indicated by a high mitigation marker for example.

In example embodiments, the risk factor may be estimated by monitoring a driving behaviour record (DBR) over time. The DBR may be a function of a “road event”, a “driver action” and an “outcome” as indicated in Equation 2 below.

DBR=(road event,risk action,outcome). Equation 2.

The vehicle apparatus may determine that a risk action has been performed (for example, harsh braking, a harsh change in direction or the like) at time t. The risk action may be represented by the function A(t). A(t) may represent a rate of change of direction or a rate of change in speed or the like which caused the vehicle apparatus to determine that a risk action occurred. A(t) is provided to the risk calculating server 300.

The risk calculating sever may analyse road events leading to risk action by reviewing a record up to time t of traffic and other external conditions and road events. For example, the risk calculating server may analyse telemetry information (received from the vehicle apparatus) from around a time at which the risk action occurred (for example, telemetry information 422, 424) and a time a which the risk action occurred (telemetry information 426).

The risk calculating server 300 may determine which telemetry information to analyse by defining a maximum delay (D) between the driver perceiving a road event which caused the risk action and a minimum delay (d) between the driver perceiving the road event which caused the risk action. The event may be any visual, audio, or mechanical movement/vibration/shock event)

Road events (which may be denoted by the letter E) occurring between t-D and t-d are then analysed and prioritised according to the threat they seem to present to the driver considered in order to determine a road event which was a most likely cause the risk action, E*.

In other words, a road event “E* causes a driver action A(t) with outcome C. The outcome C may be any consequence of the performed risk action. For example, outcomes may include a collision, a near-miss or the like.

The risk calculating server may compare with a reference driver model. The reference driver model performs risk action A*(t) in view of road event E* with an outcome C. In exemplary embodiments, the reference driver model may be a realistic model driver. For example, the reference driver model may be a driver who would pass a driving test if they performed the risk action A*(t) in view of the road event E* with the outcome C*.

The risk calculating server 300 may compare risk action A(t) with A*(t), and outcomes C with C* to determine differences/deviations.

The reference driver model may be selected by the risk calculating server to be similar to the driver who performed risk action A (t). For example, an insurance company may decide that a reference driver model should be the same age, have same driving experience, having the same vehicle, driving at the same time of day in the same conditions and geography or the like to determine a representative reference driver model. In exemplary embodiments, the reference driver model may also take into account whether it is rush hour, or whether there is decreased visibility.

By comparing the risk action A(t) with A*(t), and outcomes C with C* to determine differences/deviations, a risk factor based on the risk action deviation and the expected outcome deviation can be calculated.

In example embodiments, the risk calculating server 300 may transmit an indication of how the driver reference model performed to the vehicle apparatus so that the driver of the vehicle may learn a proportionate response to the road event E* for future reference. For example, the indication may specify that the reference driver model may have braked more smoothly and earlier in advance of the road event E*.

In example embodiments, an otherwise safe driver may perform a risk action when mitigating circumstances were present. In other words, a DBR for the driver indicates that driver scored negatively. Assume E(t−), A(t−), C(t−)) represent a negatively scoring DBR for the driver. The risk calculating server 300 may analyse a previous DBR for the driver stored in the memory 330 in which the driver scored positively. The driver may have scored positively because the driver responded safely to a road event. For example, the risk calculating server 300 may locate a road event E(t+) which is closest to E(t−) in which the driver performed risk action A(t+) with outcome C(+).

In such embodiments, the risk calculating server 300 may transmit a reminder to the driver how the driver performed for the positively scored road event (E(t+)). The reminder may include a reminder of the road event E(t+). For example, the reminder may include a time/location and a cause of the risk action. The reminder may include a reminder of risk action A(t+). For example, the reminder may include evidence of harsh braking, a harsh change in direction or the like. The reminder may include a reminder of the outcome C(t+). For example, the reminder may include an indication that a collision was avoided.

The reminder may include an indication that the driver should performing risk action A(t+) instead of risk action A(t−) for future similar road events.

Therefore a DBR may lead lower insurance fees, fewer accidents, improved driving through continuous improvement and vigilance.

In example embodiments, a learning factor, L may be introduced into the risk factor calculation. The learning value may take any value between 0 and 1 (L may be 0.9 for quick learning or 0.1 for slow learning for example). The learning factor may be used to weight previously accumulated DBR information in the calculation of the risk factor.

In example embodiments, an accumulated DBR at t, S(.), may be made smoother by defining it from an observation at s(.) with S(t+1)=L s(t+1)+(1-L) S(t). s(t) is a value of a score allocated to risk action at instant t, whereas S(t) represents a sum of scores allocated to risk actions occurring between pre-defined point in time before t and t.

In example embodiments, such a weighting may be performed every time a new journey is started. In this way, past behavior of previous journeys is taken into account with weight (1-L) and the current drive with weight L.

In example embodiments, the risk calculating server 300 may detect an anomaly in driving behavior. For example, if S represents an accumulated DBR for a driver then a sharp jump or drop in S as a function of time for example between driving sessions) may reveal a change in the driving behavior.

In such embodiments, detecting anomalies in driving behavior may be useful in particular for determining that elderly drivers may be longer fit to safely operate a vehicle. In addition, possible driving under the influence of alcohol or drugs or the like. If such events are detected, and confirmed, corrective action may then be taken.

As shown in FIG. 2, the vehicle apparatus 100 may comprise a display unit 110 configured to display information provided by the other units. For example, the display unit 110 may display one or more images captured by the one or more cameras 122. The display unit 110 may be present within the vehicle and visible to a driver of the vehicle.

In some embodiments, an input unit 150 is included within the vehicle apparatus 100 as shown in FIG. 2. The input unit 150 may be configured in combination with the display unit 110. For example, the input may represent a touch-screen interface of the display unit 110. The input unit 150 may be a keyboard. The input unit 150 is usable by a driver of the vehicle. In some embodiments, the driver may use the input unit to upload information regarding a risk action to the risk calculating server. For example, the driver may input a time around which the risk action occurred along with one or more of additional images from a time around when the risk action occurred, reasons for the risk action, faults in the vehicle or the like. In other words, the driver may use the input unit 150 to input mitigation information to the risk calculating server which may be used by an insurer in determining an insurance premium for the driver.

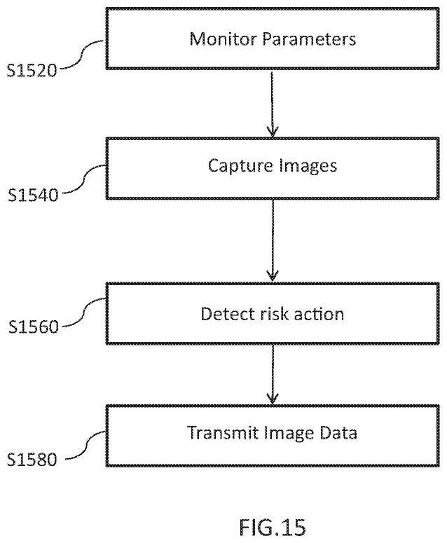

FIG. 15 illustrates a method of operating a vehicle according to exemplary embodiments. In step S1520, control circuitry in combination with one or more sensors in the vehicle monitor one or more parameters indicating a motion of the vehicle over a time period.

In step S1540, one or more cameras in the vehicle capture one or more images of a region surrounding the vehicle over the time period. The images may be captured at periodic intervals or may be moving images for example. In some examples, one or more location sensors may be used to track a location and/or position of the vehicle including the region surrounding the vehicle. Each of the one or more images may be stored with a corresponding location determined by the location sensors.

In step S1560, the control circuitry in the vehicle detects, based on the monitored parameters, that a risk action has been performed by the vehicle at a time within the time period. For example, the control circuitry may detect that harsh braking, acceleration or the like has occurred.

In step S1580, transmitter circuitry in combination with the control circuitry in the vehicle transmits image data of the one or more images of the region surrounding the vehicle and measurements of the monitored parameters indicating the motion of the vehicle over the time period to a server along with an indication that the risk action has been performed. For example, the indication of the risk action may be in the form of a risk marker which is understandable by the server. The image data may comprise feature data of the captured one or more images or the captured one or more images themselves.

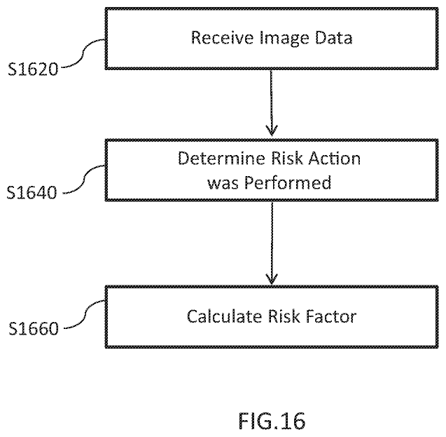

FIG. 16 illustrates a method performed by a server comprising a processor and a communications interface and executable code according to exemplary embodiments. In step S1620, the server receives, via the communications interface, image data of one or more images of a region surrounding a vehicle and measurements of one or more monitored parameters indicating a motion of a vehicle over a time period with an indication that a risk action has been performed. The server may be a risk calculating server as described herein. In some embodiments, the risk calculating server may comprise an Edge server onboard the vehicle.

In step S1640, control circuitry in the server based on at least the image data of the one or more images determines that the risk action was performed in view of mitigating circumstances. In other words, the server analyses the image data received at a time period before but around the risk action to determine if the risk action was justified.

In step S1660, the control circuitry in the server calculates a risk factor for the driver indicating a likelihood that the driver will be involved in a road traffic accident at a future time later than the time period based on at least the measurements of the monitored parameters, wherein the calculating of the risk factor accounts for the risk action having been performed in view of the mitigating circumstances. In some embodiments, the calculation disregards measurements or monitored parameters at a time around when the risk action occurred.

The following numbered paragraphs provide further example aspects and features of the present technique:

Paragraph 1. A method of operating a vehicle, the method comprising
monitoring, by control circuitry in combination with one or more sensors in the vehicle, one or more parameters indicating a motion of the vehicle over a time period, capturing, by one or more cameras in the vehicle, one or more images of a region surrounding the vehicle over the time period;
   detecting, by the control circuitry in the vehicle based on the monitored parameters, that a risk action has been performed by the vehicle at a time within the time period,
transmitting, by transmitter circuitry in combination with the control circuitry in the vehicle, image data of the one or more images of the region surrounding the vehicle and measurements of the monitored parameters indicating the motion of the vehicle over the time period to a server along with an indication that the risk action has been performed.

Paragraph 2. A method according to paragraph 1, wherein the monitored parameters include one or more of an acceleration, speed, direction of the vehicle.

Paragraph 3. A method according to paragraph 2, wherein the detecting, by the control circuitry in the vehicle based on the monitored parameters, that the risk action has been performed by the vehicle at the time within the time period, comprises detecting that a change in one or more of the acceleration, speed, direction of the vehicle with time exceeds a pre-defined threshold.

Paragraph 4. A method according to any of paragraphs 1 to 3, wherein the image data comprises the one or more images of the region surrounding the vehicle over the time period captured by the one or more cameras.

Paragraph 5. A method according to any of paragraphs 1 to 4, comprising
extracting, by the one or more cameras in combination with the control circuitry in the vehicle, feature data from the one or more images of the region surrounding the vehicle over the time period, wherein the image data comprises the extracted feature data.

Paragraph 6. A method according to any of paragraphs 1 to 5, comprising

determining, by one or more distance sensors on the vehicle, distances of the vehicle from objects in the region surrounding the vehicle;
transmitting the distances of the vehicle from the objects in the region surrounding the vehicle to the server.

Paragraph 7. A method according to any of paragraphs 1 to 6, comprising
detecting, by the control circuitry in the vehicle, that the risk action was performed autonomously;
transmitting an indication to the server that the risk action was performed autonomously.

Paragraph 8. A method according to any of paragraphs 1 to 7, wherein the transmitting, by transmitter circuitry in combination with the control circuitry in the vehicle, the image data of the one or more images of the region surrounding the vehicle and measurements of the monitored parameters indicating the motion of the vehicle over the time period to a server along with an indication that the risk action has been performed comprises
attaching, by control circuitry in the vehicle, a risk marker to the image data of the one or more of the images of the region surrounding the vehicle indicating that a risk action was performed in the one or more images.

Paragraph 9. A method according to paragraph 8, wherein the control circuitry the vehicle attaches one of a plurality of risk markers, each of the plurality of risk markers representing a severity of the risk action performed.

Paragraph 10. A method performed by a server comprising a processor and a communications interface and executable code which when executed causes the processor to perform the steps of
receiving via the communications interface image data of one or more images of a region surrounding a vehicle and measurements of one or more monitored parameters indicating a motion of a vehicle over a time period with an indication that a risk action has been performed,
determining, by control circuitry in the server based on at least the image data of the one or more images, that the risk action was performed in view of mitigating circumstances;
calculating, by the control circuitry in the server, a risk factor for the driver indicating a likelihood that the driver will be involved in a road traffic accident at a future time later than the time period based on at least the measurements of the monitored parameters, wherein the calculating of the risk factor accounts for the risk action having been performed in view of the mitigating circumstances.

Paragraph 11. A method according to paragraph 10, wherein the determining, by control circuitry in the server based on at least the one or more images, that the risk action was performed in view of mitigating circumstances comprises
determining, from image data of the one or more images captured at a time within the time period before the risk action, a probability representing a likelihood of how avoidable the risk action was;
determining that mitigating circumstances were present if the probability is determined to be lower than a pre-defined threshold.

Paragraph 12. A method according to paragraph 11, wherein the determining from the image data of the one or more images at the time within the time period before the risk action, the probability representing a likelihood of how avoidable the risk action was comprises one or more of

determining, using object recognition executable code instructions a likely cause of the risk action;
receiving, from the vehicle, distances from objects in the region surrounding the vehicle including the likely cause of the risk action determined by distance sensors on the vehicle at the time within the time period before the risk action;
determining whether or not a likely cause of the risk action was within a field of view of the driver at the time within the time period before the risk action;
determining prevailing weather conditions at the time within the time period before the risk action
determining, by the server from the measurements the one or more received monitored parameters, a speed of the vehicle at the time within the time period before the risk action, an acceleration of the vehicle at the time within the time period before the risk action, and a direction of the vehicle at the time within the time period before the risk action,
using the image data of the one or more images captured at the time within the time period before the risk action in combination with one or more of: the distances from objects in the region surrounding the vehicle at the time within the time period before the risk action occurred, the speed of the vehicle at the time within the time period before the risk action, the acceleration of the vehicle at the time within the time period before the risk action, the direction of the vehicle at the time within the time period before the risk action, whether or not a likely cause of the risk action was in a field of view of the driver at the time within the time period before the risk action, and the prevailing weather conditions at the time within the time period before the risk action to determine the probability representing the likelihood of how avoidable the risk action was.

Paragraph 13. A method according to paragraph 8, wherein the probability representing a likelihood of how avoidable the risk action is increased if the vehicle is driving over a statutory speed limit at the time within the time period before the risk action, a likely cause of the risk action is within a field of view of the driver at the time within the time period before the risk action and/or weather conditions are conducive to safe driving.

Paragraph 14. A method according to paragraph 11, wherein the determining, from the image data of the one or more images captured at a time within the time period before the risk action, the probability representing a likelihood of how avoidable the risk action was comprises
determining a probability representative of how likely the likely cause of the risk action is to intersect a path of the vehicle at the time at which the risk action occurred using the one or more images captured at the time within the time period before the risk action in combination with one or more of: the distances from objects in the region surrounding the vehicle at the time within the time period before the risk action occurred, a speed of the vehicle at the time within the time period before the risk action, an acceleration of the vehicle at the time within the time period before the risk action, whether or not a likely cause of the risk action was in a field of view of the driver at the time within the time period before the risk action, and the prevailing weather conditions at the time within the time period before the risk action.

Paragraph 15. A method according to paragraph 14, wherein the server determines that mitigating circumstances were present if the probability of intersection is above a pre-defined threshold and the likely cause of the risk action was outside a field of view of the driver at the time within the time period before the risk action occurred.

Paragraph 16. A method according to any of paragraphs 10 to 15, wherein the determining by control circuitry in the server based on at least the one or more images, that the risk action was performed in view of mitigating circumstances comprises
detecting, by control circuitry in the server, an attached risk marker.

Paragraph 17. A method according to paragraph 16, wherein the determining, by control circuitry in the server based on at least the image data of the one or more images, that the risk action was performed in view of mitigating circumstances comprises
attaching one of a plurality of mitigation markers to the one or more images with the attached risk markers, each mitigation marker representing a probability of how avoidable the risk action was.

Paragraph 18. A method according to paragraph 17 wherein that the calculating of the risk factor accounts for the risk action having been performed in view of the mitigating circumstances comprises
identifying the one or more mitigation markers and
disregarding measurements of the monitored parameters at the time at which the risk action occurred in the calculation of the risk factor.

Paragraph 19. A method according to paragraph 17 wherein that the calculating of the risk factor accounts for the risk action having been performed in view of the mitigating circumstances comprises

identifying the one or more mitigation markers and
reducing an impact of measurements of the monitored parameters at the time at which the risk action occurred in the calculation of the risk factor.

Paragraph 20. A method according to any of paragraphs 10 to 19, comprising
receiving, from the vehicle, an indication that the risk action was performed autonomously;
refining one or more algorithms used to determine when autonomous processes should be engaged.

Paragraph 21. A method according to any of paragraphs 10 to 20, wherein the server is an edge server on board the vehicle.

Paragraph 22. A sub-system for a vehicle, the sub-system comprising
one or more sensors configured to generate signals representing one or more parameters relating to a motion of the vehicle,
one or more cameras configured to capture one or more images of a region surrounding the vehicle over, and
control circuitry configured
to monitor the one or more parameters indicating the motion of the vehicle over a time period,
   to capture one or more images of the region surrounding the vehicle over the time period,
   to detect based on the monitored parameters, that a risk action has been performed by the vehicle at a time within the time period, and
to transmit image data of the one or more images of the region surrounding the vehicle and measurements of the monitored parameters indicating the motion of the vehicle over the time period to a server along with an indication that the risk action has been performed.

Paragraph 23. A sub-system according to paragraph 22, wherein the monitored parameters include one or more of an acceleration, speed, direction of the vehicle.

Paragraph 24. A sub-system according to paragraph 23, wherein the control circuitry is configured to detect, based on the monitored parameters, that the risk action has been performed by the vehicle at the time within the time period, by detecting that a change in one or more of the acceleration, speed, direction of the vehicle with time exceeds a pre-defined threshold.

Paragraph 25. A sub-system according to any of paragraphs 22 to 24, wherein the image data comprises the one or more images of the region surrounding the vehicle over the time period captured by the one or more cameras.

Paragraph 26. A camera module for use with a vehicle sub-system, the camera module comprising
an imaging device configured to capture one or more images of a region surrounding the vehicle over a time period; and
an interface configured to communicate the one or more images to control circuitry of the sub-system and to receive control signals from the control circuitry, the control circuitry configured to control the imaging device
   to capture one or more images of the region surrounding the vehicle from the imaging device over a time period, the control circuitry being responsive signals representing one or more parameters relating to a motion of the vehicle to detect based on the parameters that a risk action has been performed by the vehicle at a time within the time period, and to transmit image data of the one or more images of the region surrounding the vehicle and measurements of the monitored parameters indicating the motion of the vehicle over the time period to a server along with an indication that the risk action has been performed.

Paragraph 27. A vehicle including a sub-system according to any of paragraphs 22 to 25.

Paragraph 28. A vehicle including a camera module of paragraph 26.

Paragraph 29. A server comprising a processor and a communications interface and executable code which when executed causes the processor to perform the steps of any of paragraphs 10 to 21.

Paragraph 30. A system including a vehicle according to paragraph 27 and a server according to paragraph 29.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

1. A method of operating a vehicle, the method comprising
monitoring, by control circuitry in combination with one or more sensors in the vehicle, one or more parameters indicating a motion of the vehicle over a time period,
capturing, by one or more cameras in the vehicle, one or more images of a region surrounding the vehicle over the time period;
detecting, by the control circuitry in the vehicle based on the monitored parameters, that a risk action has been performed by the vehicle at a time within the time period,
transmitting, by transmitter circuitry in combination with the control circuitry in the vehicle, image data of the one or more images of the region surrounding the vehicle and measurements of the monitored parameters indicating the motion of the vehicle over the time period to a server along with an indication that the risk action has been performed.

2. The method according to claim 1, wherein the monitored parameters include one or more of an acceleration, speed, direction of the vehicle.

3. The method according to claim 2, wherein the detecting, by the control circuitry in the vehicle based on the monitored parameters, that the risk action has been performed by the vehicle at the time within the time period, comprises
detecting that a change in one or more of the acceleration, speed, direction of the vehicle with time exceeds a pre-defined threshold.

4. The method according to claim 1, wherein the image data comprises the one or more images of the region surrounding the vehicle over the time period captured by the one or more cameras.

5. The method according to claim 1, comprising
extracting, by the one or more cameras in combination with the control circuitry in the vehicle, feature data from the one or more images of the region surrounding the vehicle over the time period, wherein the image data comprises the extracted feature data.

6. The method according to claim 1, comprising
determining, by one or more distance sensors on the vehicle, distances of the vehicle from objects in the region surrounding the vehicle;
transmitting the distances of the vehicle from the objects in the region surrounding the vehicle to the server.

7. The method according to claim 1, comprising
detecting, by the control circuitry in the vehicle, that the risk action was performed autonomously;
transmitting an indication to the server that the risk action was performed autonomously.

8. The method according to claim 1, wherein the transmitting, by transmitter circuitry in combination with the control circuitry in the vehicle, the image data of the one or more images of the region surrounding the vehicle and measurements of the monitored parameters indicating the motion of the vehicle over the time period to a server along with an indication that the risk action has been performed comprises
attaching, by control circuitry in the vehicle, a risk marker to the image data of the one or more of the images of the region surrounding the vehicle indicating that a risk action was performed in the one or more images.

9. (canceled)

10. A method performed by a server comprising a processor and a communications interface and executable code which when executed causes the processor to perform the steps of
receiving via the communications interface image data of one or more images of a region surrounding a vehicle and measurements of one or more monitored parameters indicating a motion of a vehicle over a time period with an indication that a risk action has been performed,
determining, by control circuitry in the server based on at least the image data of the one or more images, that the risk action was performed in view of mitigating circumstances;
calculating, by the control circuitry in the server, a risk factor for the driver indicating a likelihood that the driver will be involved in a road traffic accident at a future time later than the time period based on at least the measurements of the monitored parameters, wherein the calculating of the risk factor accounts for the risk action having been performed in view of the mitigating circumstances.

11. The method according to claim 10, wherein the
determining, by control circuitry in the server based on at least the one or more images, that the risk action was performed in view of mitigating circumstances comprises determining, from image data of the one or more images captured at a time within the time period before the risk action, a probability representing a likelihood of how avoidable the risk action was;
determining that mitigating circumstances were present if the probability is determined to be lower than a pre-defined threshold.

12. The method according to claim 11, wherein the determining from the image data of the one or more images at the time within the time period before the risk action, the probability representing a likelihood of how avoidable the risk action was comprises one or more of
determining, using object recognition executable code instructions a likely cause of the risk action;
receiving, from the vehicle, distances from objects in the region surrounding the vehicle including the likely cause of the risk action determined by distance sensors on the vehicle at the time within the time period before the risk action;
determining whether or not a likely cause of the risk action was within a field of view of the driver at the time within the time period before the risk action;
determining prevailing weather conditions at the time within the time period before the risk action
determining, by the server from the measurements the one or more received monitored parameters, a speed of the vehicle at the time within the time period before the risk action, an acceleration of the vehicle at the time within the time period before the risk action, and a direction of the vehicle at the time within the time period before the risk action,
using the image data of the one or more images captured at the time within the time period before the risk action in combination with one or more of: the distances from objects in the region surrounding the vehicle at the time within the time period before the risk action occurred, the speed of the vehicle at the time within the time period before the risk action, the acceleration of the vehicle at the time within the time period before the risk action, the direction of the vehicle at the time within the time period before the risk action, whether or not a likely cause of the risk action was in a field of view of the driver at the time within the time period before the risk action, and the prevailing weather conditions at the time within the time period before the risk action to determine the probability representing the likelihood of how avoidable the risk action was.

13. The method according to claim 11, wherein the probability representing a likelihood of how avoidable the risk action is increased if the vehicle is driving over a statutory speed limit at the time within the time period before the risk action, a likely cause of the risk action is within a field of view of the driver at the time within the time period before the risk action and/or weather conditions are conducive to safe driving.

14. The method according to claim 11, wherein the determining, from the image data of the one or more images captured at a time within the time period before the risk action, the probability representing a likelihood of how avoidable the risk action was comprises
determining a probability representative of how likely the likely cause of the risk action is to intersect a path of the vehicle at the time at which the risk action occurred using the one or more images captured at the time within the time period before the risk action in combination with one or more of: the distances from objects in the region surrounding the vehicle at the time within the time period before the risk action occurred, a speed of the vehicle at the time within the time period before the risk action, an acceleration of the vehicle at the time within the time period before the risk action, whether or not a likely cause of the risk action was in a field of view of the driver at the time within the time period before the risk action, and the prevailing weather conditions at the time within the time period before the risk action.

15. The method according to claim 14, wherein the server determines that mitigating circumstances were present if the probability of intersection is above a pre-defined threshold and the likely cause of the risk action was outside a field of view of the driver at the time within the time period before the risk action occurred.

16. The method according to claim 10, wherein the determining by control circuitry in the server based on at least the one or more images, that the risk action was performed in view of mitigating circumstances comprises
detecting, by control circuitry in the server, an attached risk marker.

17. The method according to claim 16, wherein the determining, by control circuitry in the server based on at least the image data of the one or more images, that the risk action was performed in view of mitigating circumstances comprises
attaching one of a plurality of mitigation markers to the one or more images with the attached risk markers, each mitigation marker representing a probability of how avoidable the risk action was.

18. The method according to claim 17 wherein that the calculating of the risk factor accounts for the risk action having been performed in view of the mitigating circumstances comprises
identifying the one or more mitigation markers and
disregarding measurements of the monitored parameters at the time at which the risk action occurred in the calculation of the risk factor, or
reducing an impact of measurements of the monitored parameters at the time at which the risk action occurred in the calculation of the risk factor.

19. (canceled)

20. The method according to claim 10, comprising
receiving, from the vehicle, an indication that the risk action was performed autonomously;
refining one or more algorithms used to determine when autonomous processes should be engaged.

21. The method according to claim 10, wherein the server is an edge server on board the vehicle.

22. A sub-system for a vehicle, the sub-system comprising
one or more sensors configured to generate signals representing one or more parameters relating to a motion of the vehicle,
one or more cameras configured to capture one or more images of a region surrounding the vehicle over, and
control circuitry configured
to monitor the one or more parameters indicating the motion of the vehicle over a time period,
to capture one or more images of the region surrounding the vehicle over the time period,
to detect based on the monitored parameters, that a risk action has been performed by the vehicle at a time within the time period, and
to transmit image data of the one or more images of the region surrounding the vehicle and measurements of the monitored parameters indicating the motion of the vehicle over the time period to a server along with an indication that the risk action has been performed.

23-25. (canceled)
